(19) United States
(12) Patent Application Publication
(10) Pub. No.: US 2025/0209136 A1
(43) Pub. Date: Jun. 26, 2025

(54) CLASSIFYING CUSTOMER EXPERIENCE SENTIMENT USING MACHINE LEARNING

(71) Applicant: AMERICAN EXPRESS TRAVEL RELATED SERVICES COMPANY, INC., New York, NY (US)

(72) Inventors: Geetika PURI, Delhi (IN); Shalini DASGUPTA, Brighton (GB); Nilagnik CHAKRABORTY, Kolkata (IN); Luis Martin ANGEL-LALANNE, Rye Brook, NY (US); Maria E. HENSON, Oak Ridge, NC (US); Paula Lynn MONSEES, Greensboro, NC (US); Ryan M. BODNAR, Hendersonville, TN (US); Manish KUMAR, Bihar (IN); Utkarsh DADHICH, Rajasthan (IN)

(73) Assignee: AMERICAN EXPRESS TRAVEL RELATED SERVICES COMPANY, INC., New York, NY (US)

(21) Appl. No.: 18/394,200

(22) Filed: Dec. 22, 2023

(51) Int. Cl. G06F 18/2415; G06F 40/35; G06N 7/01

(52) U.S. Cl. CPC G06F 18/2415; G06F 40/35; G06N 7/01

(57) ABSTRACT

Disclosed herein are system, method, and computer program product embodiments for classifying call data using machine learning techniques. The classification may include generating a numeric sentiment classification for a call. A sentiment classification system receives data including call transcript text and metadata related to the call and preprocesses the data to generate preprocessed data. The sentiment classification system further applies the preprocessed data to a sentiment classification model trained to produce a plurality of probability values respectively corresponding to a plurality of sentiment categories. The plurality of sentiment categories correspond to different potential qualities of the call transcript text. The sentiment classification system further determines a numeric sentiment classification based on comparing the plurality of probability values to a plurality of thresholds respectively corresponding to the plurality of sentiment categories. The numeric sentiment classification corresponds to a quality of the call.

### BACKGROUND

### Field

This field is generally related to classifying customer service call data using machine learning (ML) techniques.

### Related Art

As customer care and customer experience technology continues to evolve, businesses face the issue of effectively evaluating customer care professionals (CCPs) and customer experiences. For example, a particular CCP may handle a customer care call, and a survey may be provided at the end of the call for a corresponding customer to evaluate the quality of the call. However, the rate of customers participating in this kind of survey is usually low-sometimes too low to accurately evaluate a CCP's performance. While additional call data may be collected, the processing of such data is lacking and also does not accurately capture or evaluate an effectiveness of service.

### BRIEF SUMMARY

Disclosed herein are system, apparatus, device, method and/or computer program product embodiments, and/or combinations and sub-combinations thereof, for classifying call data using machine learning techniques. The classification may include generating a numeric sentiment classification for a call.

In some embodiments, a sentiment classification system receives data including call transcript text and metadata related to the call and preprocesses the data to generate preprocessed data. The sentiment classification system may receive call data from a system configured to track call data, log call data, and/or generate transcript information. In some embodiments, the sentiment classification system may receive the call data after a sentiment classification model has been trained with training data. The sentiment classification system may apply the preprocessed data to a sentiment classification model trained to produce a plurality of probability values respectively corresponding to a plurality of sentiment categories.

The plurality of sentiment categories may correspond to different potential qualities of the call transcript text. The sentiment classification system may determine a numeric sentiment classification based on comparing the plurality of probability values to a plurality of thresholds respectively corresponding to the plurality of sentiment categories. In some embodiments, if a particular probability value exceeds a corresponding threshold while one or more of the other probability values fall below their respective thresholds, the sentiment classification system may assign the sentiment classification with the probability value exceeding the threshold to the call data. The numeric sentiment classification may correspond to a quality of the call.

The numeric sentiment classification may be considered a customer experience metric corresponding to the call. This customer experience metric may further be used, applied, and/or saved to an account corresponding to the corresponding customer care professional that handled the call. For example, this data and/or the determined metrics may be used for evaluation of a customer care professional's performance.

The sentiment classification model may be trained using training data including call transcripts, metadata, and/or survey scores. For example, the sentiment classification model may extract a plurality of text features and/or factors from preprocessed training data. The sentiment classification model may generate a plurality of probability values respectively corresponding to a plurality of sentiment categories based on the metadata, the extracted features, and/or the survey score for a call. If a survey score indicates an “excellent” call, the sentiment classification model may be trained to produce a higher probability value for an “excellent” sentiment category when receiving future transcript data with similar features. The sentiment classification model may also generate probability values for other categories as well. These may include a “very good or good” category and/or a “fair or poor” category.

### BRIEF DESCRIPTION OF THE DRAWINGS

The accompanying drawings are incorporated herein and form a part of the specification.

FIG. 1A depicts a block diagram of a sentiment classification environment, according to some embodiments.

FIG. 1B depicts a block diagram of a data flow for a sentiment classification model, according to some embodiments.

FIG. 2 depicts a flowchart illustrating a method for training a sentiment classification system, according to some embodiments.

FIG. 3 depicts a flowchart illustrating a method for generating a numeric sentiment classification, according to some embodiments.

FIG. 4 depicts a flowchart illustrating a method for generating a numeric sentiment classification for a plurality of customer care agents, according to some embodiments.

FIG. 5 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for classifying customer service calls using machine learning (ML) techniques.

An automatic system and method to evaluate a customer care call based on corresponding metadata and call transcript may be desired for many businesses. Disclosed herein are system, apparatus, device, method and/or computer program product embodiments, and/or combinations and sub-combinations thereof, for generating a numeric sentiment classification for call data. The call data may correspond to a telephone call and/or a customer service call.

In some embodiments, a sentiment classification system receives data including call transcript text and metadata related to a call and preprocesses the data to generate preprocessed data. The sentiment classification system may receive call data from a system configured to track call data, log call data, and/or generate transcript information. In some embodiments, the sentiment classification system may receive the call data after a sentiment classification model has been trained with training data. The sentiment classification system may apply the preprocessed data to a sentiment classification model trained to produce a plurality of probability values respectively corresponding to a plurality of sentiment categories.

The plurality of sentiment categories may correspond to different potential qualities of the call transcript text. The sentiment classification system may determine a numeric sentiment classification based on comparing the plurality of probability values to a plurality of thresholds respectively corresponding to the plurality of sentiment categories. In some embodiments, if a particular probability value exceeds a corresponding threshold while one or more of the other probability values fall below their respective thresholds, the sentiment classification system may assign the sentiment classification with the probability value exceeding the threshold to the call data. The numeric sentiment classification may correspond to a quality of the call.

Various embodiments of these features will now be discussed with respect to the corresponding figures.

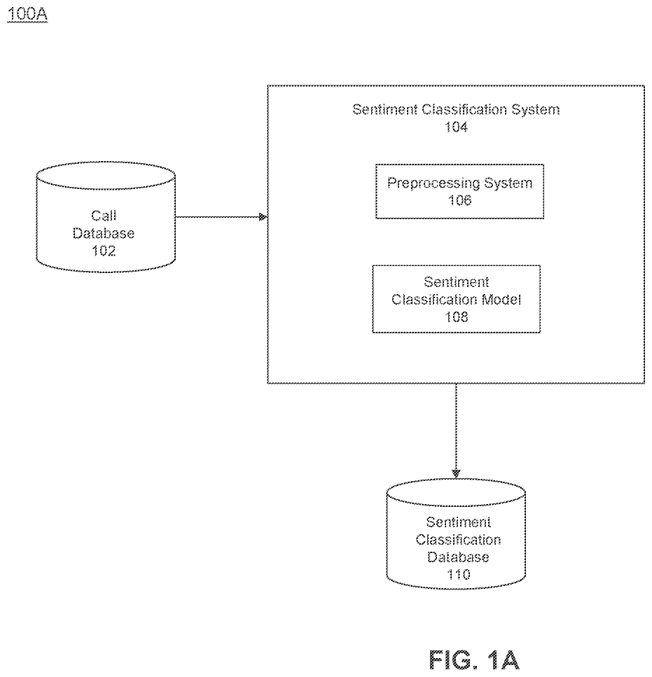

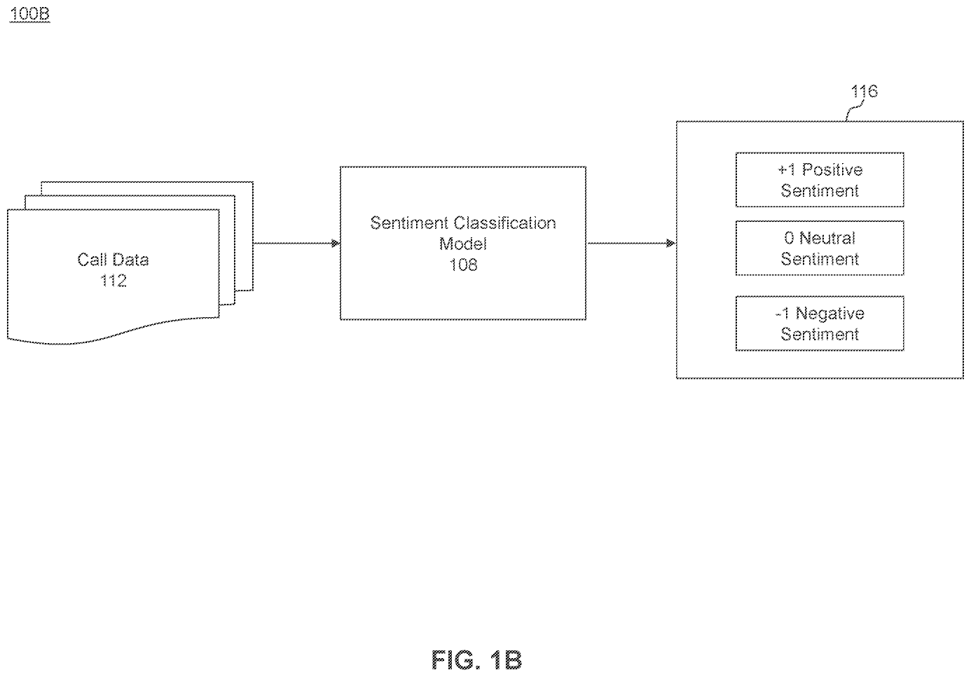

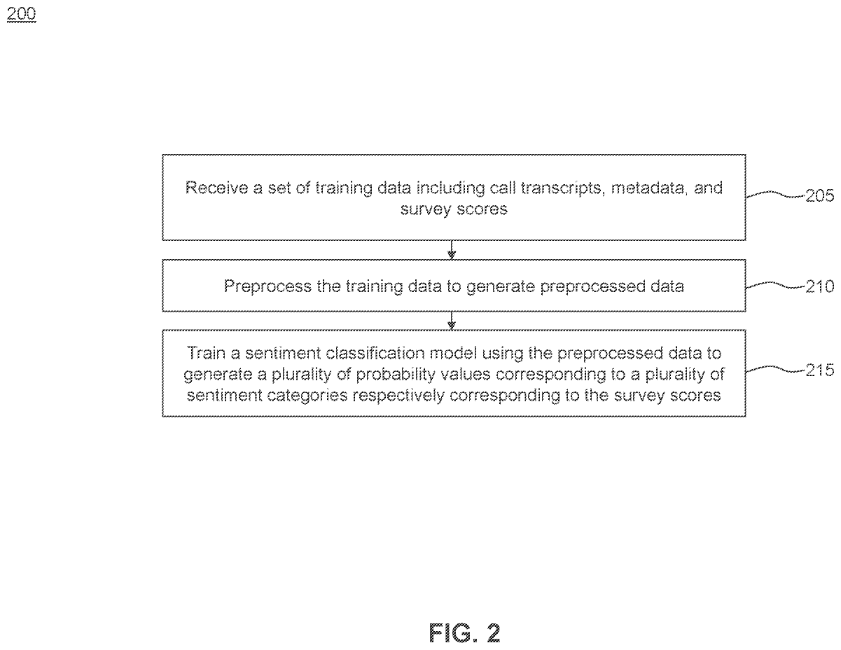

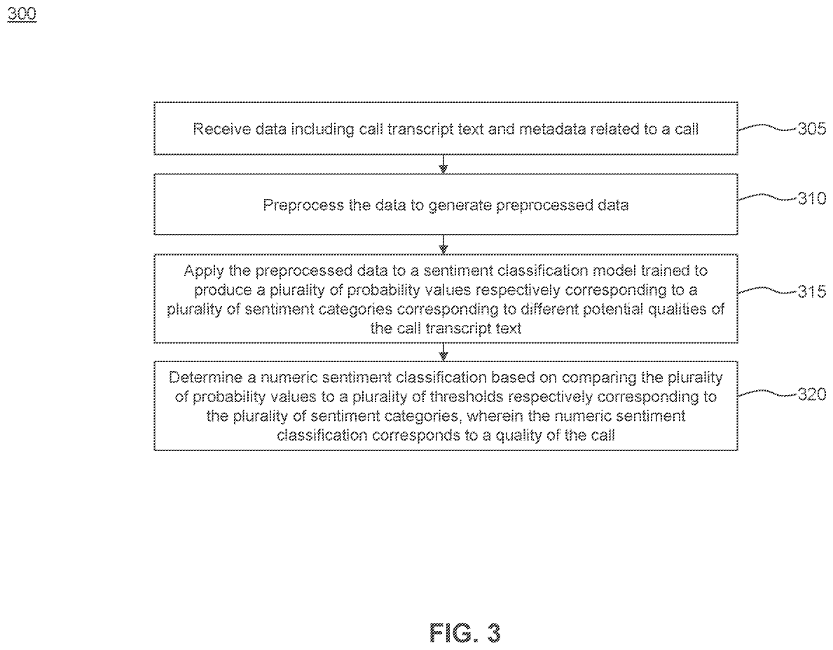

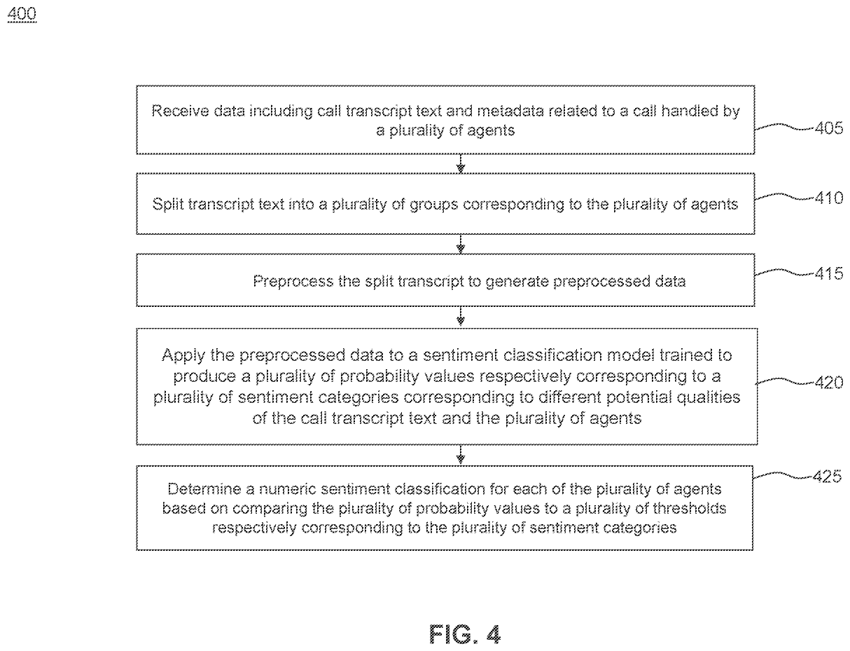

FIG. 1A depicts a block diagram of a sentiment classification environment 100A, according to some embodiments. Sentiment classification environment 100A includes sentiment classification system 104, call database 102, and/or sentiment classification database 110. Sentiment classification system 104 may include preprocessing system 106 and/or sentiment classification model 108. As further described below, sentiment classification system 104 may execute the methods and/or programming described with reference to FIG. 2, FIG. 3, and/or FIG. 4. Sentiment classification environment 100A or sentiment classification system 104 may classify call data stored in call database 102. Sentiment classification system 104 may also generate corresponding sentiment classification data and/or store this classification data in sentiment classification database 110.

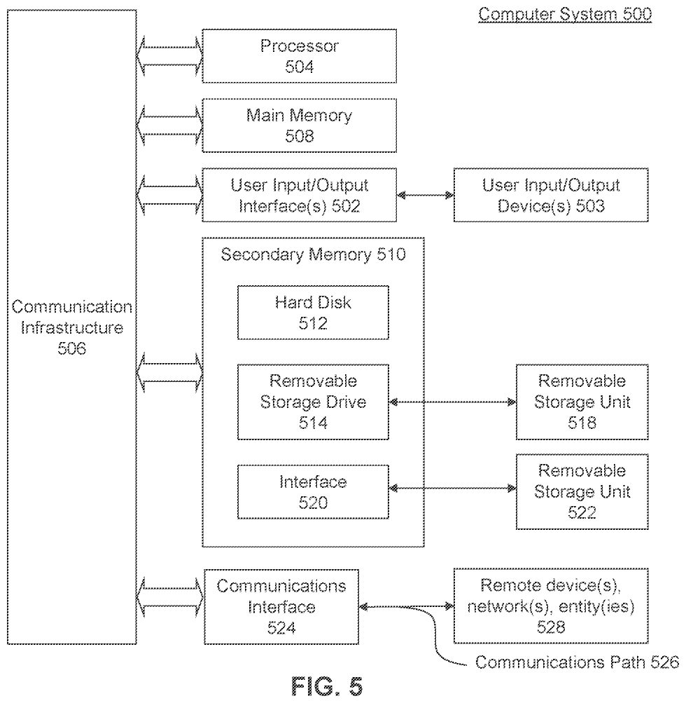

Sentiment classification system 104, call database 102, and/or sentiment classification database 110 may be implemented using a computer system, such as computer system 500 described with reference to FIG. 5. For example, sentiment classification system 104, call database 102, and/or sentiment classification database 110 may be implemented using one or more servers and/or databases. In some embodiments, sentiment classification system 104, call database 102, and/or sentiment classification database 110 may be implemented using a computing device such as a desktop workstation, laptop or notebook computer, netbook, tablet, smart phone, and/or other computing device. In some embodiments, sentiment classification system 104, call database 102, and/or sentiment classification database 110 may be implemented as an application in an enterprise computing system.

Sentiment classification system 104 may be configured to analyze data and/or records related to calls. This call data may include call transcript text and/or metadata related to a telephone call. For example, call record data may be retrieved and/or stored in call database 102 for analysis. In some embodiments, sentiment classification system 104 may receive call data from a system configured to track call, log calls, and/or generate transcript information. As further described below, sentiment classification system 104 may analyze the call transcript text and/or metadata to categorize and/or classify the call. This categorization and/or classification may reflect a sentiment related to the call, a sentiment related to one or more of the parties to the call, a quality of service provided by a customer care professional, and/or other sentiment related to the call. The analysis may produce a customer experience metric corresponding to the call. This customer experience metric may further be used, applied, and/or saved to an account corresponding to the customer care professional. For example, this data and/or the determined metrics may be used for evaluation of a customer care professional's performance. To generate the sentiment metrics, sentiment classification system 104 may use preprocessing system 106 and/or sentiment classification model 108.

Preprocessing system 106 may preprocess call data stored in call database 102. This call data may be raw call data. The call data may include call transcript text and/or metadata related to a call. The metadata may include duration of the call, cross talk, no speech duration, and/or other statistical data related to the call. The metadata may also include a previously generated and/or predicted sentiment score corresponding to a particular call. Preprocessing system 106 may sanitize call transcript text as further described below.

In some embodiments, preprocessing system 106 may split transcript text into a plurality of groups. These groups may correspond to a plurality of customer care professionals (CCPs) or customer care agents. For example, preprocessing system 106 may separate the call transcript text to a plurality of portions corresponding to more than one customer care agent when the call corresponds to the more than one customer care agent. Each transcript group may be marked corresponding to the related agent.

Preprocessing system 106 may also manipulate the text of the call transcript. For example, this may generate text data that sentiment classification model 108 may more accurately classify and/or categorize. For example, this may include removing textual data that does not aid in the identification of a sentiment corresponding to the call. Preprocessing system 106 may remove call transcript text corresponding to utterances from a customer care agent from the call data. For example, a CCP may use positive words and/or language which may inaccurately reflect the sentiment of a customer receiving care if such utterances were considered. Preprocessing system 106 may also modify the text of the call transcript by replacing similar words with a predetermined word. This may aid in more accurately classifying the call and/or the sentiment of the call. In some embodiments, preprocessing system 106 may also filter and/or remove null call transcripts and/or portions of call transcripts where the number of customer utterances is below a particular threshold. For example, a particular call transcript may be flagged and/or removed from consideration if a customer receiving care has not spoken for a particular amount of time. Similarly, a transcript may be removed and/or not considered if the customer's percentage of utterances in a call transcript is below a particular threshold.

As further explained below, sentiment classification model 108 may classify and/or categorize a particular call transcript. This may be a classification of a call transcript that has been pre-processed by preprocessing system 106. Sentiment classification model 108 may be a machine learning model and/or a language model that classifies calls corresponding to the call data into different sentiment classifications. Sentiment classification system 104 may store these classifications in sentiment classification database 110.

FIG. 1B depicts a block diagram of a data flow for a sentiment classification model 108, according to some embodiments. After call data 112 is preprocessed by preprocessing system 106 (not shown in FIG. 1B), sentiment classification model 108 classifies the preprocessed call data into different sentiment classifications. Examples of different sentiment classifications include numeric sentiment classifications 116. Sentiment classifications 116 may include +1 (positive sentiment), 0 (neutral sentiment), and −1 (negative sentiment). While numeric sentiment classifications 116 are depicted, other ranking and/or grading may also be applied to call data 112. In some embodiments, these sentiment values may also be referred to as “vibes.” In some embodiments, sentiment classification model 108 extracts a plurality of text features and/or factors from the preprocessed data. This may be text data used by sentiment classification model 108 and/or similar to the text data used to train sentiment classification model 108. For example, some words and/or phrases may be designated with a suggestion toward a particular sentiment. In some embodiments, sentiment classification model 108 may disregard certain text features and/or portions of textual call data. For example, sentiment classification model 108 may identify irrelevant features and/or factors that are not associated with a customer sentiment. For example, words uttered by a customer care agent may be disregarded and/or assigned less weight. In some embodiments, sentiment classification model 108 may also be trained to disregard words that may not be related to a particular customer care agent's performance. For example, terms like “cancellation” or “fee waiver” may correspond to a negative sentiment, but may not be related to the customer care agent's performance. In this case, such terms may be removed from the call data. This may be performed as part of preprocessing and/or as part of the sentiment classification of the call data.

Sentiment classification model 108 may apply the preprocessed data to produce a plurality of probability values corresponding to a plurality of sentiment categories and/or sentiment classifications 116. The classification of call data corresponding to a particular call may be based on the relevant extracted features. The plurality of sentiment classifications 116 may respectively correspond to different potential qualities of the call transcript text. Sentiment classification model 108 may determine a numeric sentiment classification 116 based on comparing the plurality of probability values to a plurality of thresholds. The plurality of thresholds may respectively correspond to the plurality of sentiment classifications 116, and the numeric sentiment classification 116 may correspond to a quality of the call. FIGS. 2, 3, and 4 provide additional details related to preprocessing call and/or determining a particular sentiment classification 116.

To illustrate an example of this classification process, sentiment classification model 108 may produce three probability values corresponding to three sentiment classifications 116. A first classification may correspond to an “excellent” grade; a second classification may correspond to a “very good or good” grade; and a third classification may corresponding to a “fair or poor” grade. Sentiment classification model 108 may analyze the call data and generate probability values for each of these three sentiment classifications 116. Sentiment classification model 108 may then compare each of the three probability values to respective thresholds corresponding to each of the sentiment classifications 116. The comparison to the thresholds may determine the particular sentiment classification 116 to apply to the call data. In some embodiments, if a particular probability value exceeds a corresponding threshold while one or more of the other probability values fall below their respective thresholds, sentiment classification model 108 may assign the sentiment classification 116 with the probability value exceeding the threshold to the call data.

For example, an “excellent” category may have a probability value of 75% with a corresponding threshold of 70%. A “very good or good” category may have a probability value of 15% with a threshold of 60% and a “fair or poor” category may have a probability of 10% with a threshold of 75%. In this case, because the “excellent” probability value exceeds its corresponding threshold and the other probability values fall below theirs, sentiment classification model 108 may assign the call data producing the probability values to the “excellent” category. Other thresholds and/or a different number of categories may also be utilized as further explained below. These categories may also be assigned numeric sentiment classifications as further explained below. For example, if the probability of a call having an excellent vibe is above 0.65 and the probability of the call having a poor vibe is below 0.2, sentiment classification model 108 may assign a numeric sentiment classification of +1. If the probability of the call having a poor vibe is above 0.45 and the probability of the call having an excellent vibe is below 0.3, sentiment classification model 108 may assign a numeric sentiment classification of −1. Other probability value comparisons to thresholds may be assigned with a numeric sentiment classification of 0. This may correspond to a neutral vibe or neutral classification.

FIG. 2 depicts a flowchart illustrating a method 200 for training a sentiment classification system, according to some embodiments. Method 200 shall be described with reference to FIG. 1A; however, method 200 is not limited to that example embodiment.

In an embodiment, sentiment classification system 104 may utilize method 200 to train a sentiment classification model 108. Training data may be received and/or retrieved from call database 102. Sentiment classification system 104 may train sentiment classification model 108 to predict a sentiment, quality, or overall customer satisfaction level of a call. The foregoing description will describe an embodiment of the execution of method 200 with respect to sentiment classification system 104. While method 200 is described with reference to sentiment classification system 104, method 200 may be executed on any computing device, such as, for example, the computer system described with reference to FIG. 5 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 2, as will be understood by a person of ordinary skill in the art.

At 205, sentiment classification system 104 may receive a set of training data including call transcripts, metadata, and/or survey scores. The set of training data may be stored in call database 102. The call transcript data may include text data and/or a text file reflecting a customer service call. Metadata may include timestamps, crosstalk identification, non-speech indicators, and/or other data corresponding to the call. In some embodiments, this metadata may reflect a particular sentiment. For example, a longer call duration, higher amounts of crosstalk, and/or higher amounts of non-speech may indicate a negative sentiment. Sentiment classification system 104 may be trained to consider these factors based on the metadata correlated to a particular survey score and/or based on a labeling applied to the training data. The survey scores may be scores provided by customers at the end of customer service calls. The call data may correlate the survey scores to the call transcript data and/or the metadata. Sentiment classification system 104 may receive the training data from an external system and/or load the training data from call database 102 or another call data repository. For example, sentiment classification system 104 may be configured to retrieve the training data from a particular folder and/or place in memory.

At 210, sentiment classification system 104 may preprocess the training data to generate preprocessed data. This may include selecting and/or sanitizing the text of the call transcript. In some embodiments, preprocessing system 106 and/or another application may separate the call transcript text to a plurality of portions. The portions may correspond to different customer care agents. For example, the call transcript text may correspond to a call corresponds where multiple customer care agents assist a particular customer. This preprocessing may reduce noise in the call data. For example, preprocessing system 106 may remove call transcript text corresponding to a customer care agent from the data, remove null call transcripts portions and/or transcripts where the number of customer utterances is below the fifth percentile of the overall distribution of customer utterances in call transcripts. This preprocessing may also modify call text data by replacing similar words with a predetermined word. As a result of this preprocessing, sentiment classification system 104 may generate a clean version of call data which removes irrelevant words for sentiment classification.

In some embodiments, call data for a particular call may comprise two audio transcripts, labels, and/or fields. The audio transcripts may have been provided by an external call processing system. The external system may have provided two versions of an audio transcript: one being a tagged version and the other being a tag-corrected version generated from a rule-based algorithm. These may generate fields having differing values. For example, a particular field may correspond to a count of customer utterances. The provided tags, however, may have differing count values. Sentiment classification system 104 may identify these different counts and use them for determining whether a particular transcript includes outlier information. For example, sentiment classification system 104 may identify outlier transcripts to exclude from use as training data. The percentile calculation to determine outliers or null transcripts (e.g., transcripts where the number of customer utterances is below a threshold) may be performed when the customer utterance count is significantly different between the two fields. The threshold, such as the fifth percentile, may be decided based on results from an underlying machine-learning algorithm, manually analyzing the samples, and/or the like. For example, when a number of customer utterances is below five percent of text data in a particular transcript, that transcript may be excluded from training. Null transcripts may not be included for training or sentiment prediction analysis.

Sentiment classification system 104 may also replace similar words with a predetermined word when preprocessing transcript data. This preprocessing may be based on call transcript data after call transcript text corresponding to the customer care agent has been removed. For example, this replacement may be performed on the remaining text corresponding to words spoken by a customer. This preprocessing may save computing resource and/or improve sentiment classification efficiency when applied to the sentiment classification model 108. For example, sentiment classification model 108 may perform more targeted and accurate classification of call data relative to analyze text that has not been preprocessed and/or sanitized. As part of word replacement, similar context word clusters may be generated. For example, the clusters may be generated using a machine-learning model or natural language processing (NLP) model trained on call transcripts. This way, similar words may be replaced with a particular predetermined common word. This replacement may result in a drastic reduction of the vocabulary size to be analyzed by sentiment classification model 108. For example, names of all the months may be replaced by the term “month.” This replacement may occur because the names of the months may be often used in similar contexts. Similarly, names of weekdays may be replaced by “day,” and states of the United States may be replaced by “state.” As another example, when a conversation addresses user identifier (ID), passwords, and/or biometrics, such words may be contextualized around authentication.

At 215, sentiment classification system 104 may train a sentiment classification model 108 using the preprocessed data to generate a plurality of probability values corresponding to a plurality of sentiment categories. The plurality of sentiment categories may respectively correspond to the survey scores. For example, sentiment classification model 108 may be trained to produce three probability values for three sentiment categories. A first, second, and third probability value may be generated corresponding to a first, second, and third sentiment categories, respectively, for a particular set of call data. The first sentiment category may correspond to an excellent quality of the call or call transcript text; the second sentiment category may correspond to a very good or good quality of the call; and the third sentiment category may correspond to a fair or poor quality of the call. The first, second, and third probability values may be generated based on the metadata, the call transcript including extracted features, and/or the survey score for the call. When training the sentiment classification model 108, model weights may be modified according to the survey score to produce the probability values. For example, if a survey score indicates an “excellent” call, sentiment classification model 108 may be trained to produce a higher probability value for the “excellent” category when receiving future transcript data with similar features. Other categorizations and/or quantities of categories may also be used.

In some embodiments, sentiment classification system 104 or sentiment classification model 108 may weigh text features from the preprocessed data. The preprocessed data may not include call transcript text corresponding to the customer care agent because the corresponding call transcript text has been removed in the preprocessing step. The weighing of text features may be performed on the remaining text corresponding to words spoken by a customer. For example, the weight of generic words, which may appear across various transcripts, may be reduced. Features may be weighed based on various techniques such as Term Frequency-Inverse Document Frequency (TF-IDF). The features may include TF-IDF features, call related features, NLP-based features, and/or other weighted features. Call related features may include sentiment of the call and/or duration of the call. In the context of customer service calls for providing credit card services, NLP-based features may be created for identifying common card related problems. For example, terms like “cancellation” or “fee waiver” may indicate the presence of a strongly negative word but may not be indicative of a particular customer care agent's performance. In this case, these data features may not be used in training sentiment classification model 108.

Sentiment classification system 104 or sentiment classification model 108 may assign different features with different weights, e.g., based on the importance of each feature. For example, sentiment classification model 108 may recognize more important words such as “awesome” and assign them with a higher weight than words that are less important to sentiment classification. This weighting may identify and/or weigh words based on relative importance of the identified text features. These text features may include words and/or phrases.

Call data stored in call database 102 may be divided into groups of training data and verification/testing data. The training data may be used to train sentiment classification model 108. The testing data may be applied to sentiment classification model 108 to test and/or re-train the probability values generated. For example, sentiment classification system 104 may compare numeric sentiment classifications of calls with survey scores corresponding to the calls. Sentiment classification system 104 may calibrate or retrain sentiment classification model 108 so that the predicted sentiment classification and/or probability values align with the survey score provided with the training data. Sentiment classification model 108 may adjust which features to extract and/or weights of the features, e.g., based on the comparison result. For example, when the rate of numeric sentiment classifications overlapping with survey scores is lower than a predetermined threshold, sentiment classification model 108 may be retrained. The predetermined threshold and/or weights may be dynamically changed when deviations are detected.

FIG. 3 depicts a flowchart illustrating a method 300 for generating a numeric sentiment classification, according to some embodiments. Method 300 shall be described with reference to FIG. 1A; however, method 300 is not limited to that example embodiment.

In an embodiment, sentiment classification system 104 may utilize method 300 to generate a sentiment classification for a call. In some embodiments, this may be a numeric sentiment classification. The classification may predict a sentiment, quality, or overall customer satisfaction level of the call. The foregoing description will describe an embodiment of the execution of method 300 with respect to sentiment classification system 104. While method 300 is described with reference to sentiment classification system 104, method 300 may be executed on any computing device, such as, for example, the computer system described with reference to FIG. 5 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3, as will be understood by a person of ordinary skill in the art.

At 305, sentiment classification system 104 may receive data including call transcript text and metadata related to a call. The data may be call data stored in call database 102. Sentiment classification system 104 may receive the call data from an external system or load the call data from call database 102 or another call data repository. For example, sentiment classification system 104 may be configured to retrieve the call data from a particular folder and/or place in memory. In some embodiments, this may occur in a manner similar to 205 as describe with reference to FIG. 2. In some embodiments, sentiment classification system 104 may receive the call data after sentiment classification model 108 has been trained with training data. In method 300, sentiment classification model 108 may be used to categorize a particular call corresponding to the received data at 305.

At 310, sentiment classification system 104 may preprocess the data to generate preprocessed data. This may include selecting and/or sanitizing the text of the call transcript. This may occur in a manner similar to 210 as described with reference to FIG. 2. The preprocessed version of the transcript may be a format that provides a more accurate and/or effective identification of relevant information for classification.

At 315, sentiment classification system 104 may apply the preprocessed data to a sentiment classification model 108 trained to produce a plurality of probability values corresponding to a plurality of sentiment categories. The plurality of sentiment categories may respectively correspond to different potential qualities of the call transcript text. For example, a first, second, and third probability values may be generated corresponding to a first, second, and third sentiment categories, respectively, for a call. The first sentiment category may correspond to an excellent quality of the call or call transcript text, the second sentiment category may correspond to a very good or good quality of the call, and the third sentiment category may correspond to a fair or poor quality of the call. Other categorizations and/or quantities of categories may also be used.

In a manner similar to 210 as described with reference to FIG. 2, sentiment classification system 104 or sentiment classification model 108 may extract and/or remove text features from the preprocessed data, and/or assign different features with different weights. Sentiment classification model 108 may generate the first, second, and third probability values based on the metadata, and/or the call transcript including the extracted features.

At 320, sentiment classification system 104 may determine a numeric sentiment classification based on comparing the plurality of probability values to a plurality of thresholds. The plurality of thresholds may respectively correspond to the plurality of sentiment categories, and the numeric sentiment classification may correspond to a quality of the call.

For example, first, second, and third thresholds may correspond to first, second, and third sentiment categories, respectively. In some embodiments, more than one threshold may correspond to a particular sentiment category. Sentiment categories may be expressed as numeric values. For example, a “+1” numeric sentiment classification may correspond to a positive sentiment of the call, a “0” numeric sentiment classification may correspond to a neutral sentiment of the call, a “−1” numeric sentiment classification may correspond to a negative sentiment of the call. Sentiment classification model 108 may have been trained in the manner described with reference to FIG. 2 to generate probability values corresponding to numeric sentiment classifications as well.

As previously explained, sentiment classification system 104 may compare the determine probability values to respective thresholds to determine a particular sentiment category. This may apply to numeric sentiment categories as well. For example, each numeric sentiment category may have a respective probability threshold. Sentiment classification system 104 may categorize a particular call transcript depending on whether one or more probability values meet, exceed, and/or fall below a particular threshold value. For example, if the probability of a call having an excellent vibe is above 0.65 and the probability of the call having a poor vibe is below 0.2, then the numeric sentiment classification may be +1. If the probability of the call having a poor vibe is above 0.45 and the probability of the call having an excellent vibe is below 0.3, then the numeric sentiment classification may be −1. Other probability value comparisons to thresholds may be assigned with a numeric sentiment classification of 0. This may correspond to a neutral vibe or neutral classification.

FIG. 4 depicts a flowchart illustrating a method 400 for generating a numeric sentiment classification 116 for a plurality of customer care agents, according to some embodiments. Method 400 shall be described with reference to FIG. 1A; however, method 400 is not limited to that example embodiment.

In an embodiment, sentiment classification system 104 may utilize method 400 to generate a numeric sentiment classification for a call associated with a plurality of customer care agents. This sentiment classification may predict a sentiment, quality, or overall customer satisfaction level of the call. The foregoing description will describe an embodiment of the execution of method 400 with respect to sentiment classification system 104. While method 400 is described with reference to sentiment classification environment 100A or sentiment classification system 104, method 400 may be executed on any computing device, such as, for example, the computer system described with reference to FIG. 5 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 4, as will be understood by a person of ordinary skill in the art.

At 405, sentiment classification system 104 can receive data including call transcript text and metadata related to a call handled by a plurality of agents. For example, text of the transcript may include portions corresponding to multiple customer care agents. The multiple customer care agents may be providing customer service to a particular customer. In some embodiments, the metadata may indicate and/or distinguish different customer care agents in the transcript text. Sentiment classification system 104 may receive the call data from an external system or load the call data from call database 102 or another call data repository. For example, sentiment classification system 104 may be configured to retrieve the call data from a particular folder and/or place in memory. In some embodiments, this may occur in a manner similar to 205 as describe with reference to FIG. 2.

At 410, sentiment classification system 104 or preprocessing system 106 may split transcript text into a plurality of groups corresponding to the plurality of agents. This may happen when a customer care call is handled by more than one customer care agent and a numeric sentiment classification may be desirable for each of the customer care agents. For example, preprocessing system 106 may identify portions of transcript text corresponding to each of the different agents. Splitting the transcript text may include labeling and/or identify the different portions. This may aid in designating a numeric sentiment classification for the particular agent. For example, this may aid in analyzing a particular agent's performance.

At 415, sentiment classification system 104 may preprocess the split transcript to generate preprocessed data. This may include selecting and/or sanitizing the text of the call transcript. This may occur in a manner similar to 210 as described with reference to FIG. 2. The preprocessed version of the transcript may be a format that provides a more accurate and/or effective identification of relevant information for classification.

At 420, sentiment classification system 104 may apply the preprocessed data to a sentiment classification model trained to produce a plurality of probability values, such as sentiment classification model 108. The plurality of probability values may respectively correspond to a plurality of sentiment categories, and the plurality of sentiment categories may correspond to different potential qualities of the call transcript text and the plurality of agents. This may occur in a manner similar to 315 as described with reference to FIG. 3. At 420, sentiment classification system 104 may determine multiple probability values for each portion of the call transcript. For example, sentiment classification system 104 may determine multiple probability values for each portion of the transcript text that corresponds to each associated agent.

At 425, sentiment classification system 104 may determine a numeric sentiment classification for each of the plurality of agents based on comparing the plurality of probability values to a plurality of thresholds. This may occur in a manner similar to 320 as described with reference to FIG. 3 for each portion of the transcript text that corresponds to the associated agent. For example, a first agent may have provided customer care eliciting a negative sentiment and/or reaction. Sentiment classification system 104 may recognize this sentiment based on its training and considered factors and may generate probability values and/or a numeric sentiment classification indicating this negative sentiment. For example, sentiment classification system 104 may assign a-1 value to this portion of the transcript and/or to the agent for this particular call. Similarly, a second agent may have provided customer care eliciting a positive sentiment and/or reaction. For example, the call may have been transferred from the first agent to the second agent. Sentiment classification system 104 may recognize this sentiment based on its training and considered factors and may generate probability values and/or a numeric sentiment classification indicating this positive sentiment. For example, sentiment classification system 104 may assign a +1 value to this portion of the transcript and/or to the agent for this particular call. In this manner, sentiment classification system 104 may classify portions of the call transcript and/or evaluate different agents accordingly.

While FIG. 3 and FIG. 4 describe methods for determining numeric sentiment classifications, sentiment classification system 104 may also be configured to use and/or provide these numeric sentiment classifications to evaluate the performance of a customer care agent. For example, sentiment classification system 104 may generate a summation of numeric sentiment classifications to aid in evaluating an agent's performance. If a positive sentiment corresponds to a positive numeric sentiment classification value, the summation may produce a greater number as the number of calls considered increases. Similarly, if a particular agent elicits negative sentiments, this may collectively sum to a negative numeric sentiment classification value. This may provide a way of determining a performance evaluation. This may aid by replacing a survey process used for feedback.

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method, comprising:
receiving data including call transcript text and metadata related to a call;
preprocessing the data to generate preprocessed data;
applying the preprocessed data to a sentiment classification model trained to produce a plurality of probability values respectively corresponding to a plurality of sentiment categories corresponding to different potential qualities of the call transcript text; and
determining a numeric sentiment classification based on comparing the plurality of probability values to a plurality of thresholds respectively corresponding to the plurality of sentiment categories, wherein the numeric sentiment classification corresponds to a quality of the call.

2. The computer implemented method of claim 1, wherein the preprocessing further comprises:
removing call transcript text corresponding to a customer care agent from the data.

3. The computer implemented method of claim 1, wherein the preprocessing further comprises:
replacing one or more similar words from the call transcript text with a predetermined word.

4. The computer implemented method of claim 1, wherein the plurality of sentiment categories include a positive numerical category, a negative numerical category, and a neutral category.

5. The computer implemented method of claim 1, wherein the metadata includes crosstalk identification.

6. The computer implemented method of claim 1, wherein the applying further comprises:
extracting a plurality of text features from the preprocessed data.

7. The computer implemented method of claim 6, wherein the plurality of text features are weighted based on relative importance by the sentiment classification model.

8. The computer implemented method of claim 1, wherein the preprocessing further comprises:
separating the call transcript text into a plurality of portions corresponding to a plurality of customer care agents.

9. A system, comprising:
a memory; and
at least one processor coupled to the memory and configured to:
receive data including call transcript text and metadata related to a call;
preprocess the data to generate preprocessed data;
apply the preprocessed data to a sentiment classification model trained to produce a plurality of probability values respectively corresponding to a plurality of sentiment categories corresponding to different potential qualities of the call transcript text; and
determine a numeric sentiment classification by comparing the plurality of probability values to a plurality of thresholds respectively corresponding to the plurality of sentiment categories, wherein the numeric sentiment classification corresponds to a quality of the call.

10. The system of claim 9, wherein to preprocess the data, the at least one processor is further configured to:
remove call transcript text corresponding to a customer care agent from the data.

11. The system of claim 9, wherein to preprocess the data, the at least one processor is further configured to:
replace one or more similar words from the call transcript text with a predetermined word.

12. The system of claim 9, wherein the plurality of sentiment categories include a positive numerical category, a negative numerical category, and a neutral category.

13. The system of claim 9, wherein the metadata includes crosstalk identification.

14. The system of claim 9, wherein to apply the preprocessed data to the sentiment classification model, the at least one processor is further configured to:
extract a plurality of text features from the preprocessed data.

15. The system of claim 14, wherein the plurality of text features are weighted based on relative importance by the sentiment classification model.

16. The system of claim 9, wherein to preprocess the data, the at least one processor is further configured to:
separate the call transcript text into a plurality of portions corresponding to a plurality of customer care agents.

17. A non-transitory computer-readable device having instructions stored thereon that, when executed by at least one computing device, cause the at least one computing device to perform operations comprising:
receiving data including call transcript text and metadata related to a call;
preprocessing the data to generate preprocessed data;
applying the preprocessed data to a sentiment classification model trained to produce a plurality of probability values respectively corresponding to a plurality of sentiment categories corresponding to different potential qualities of the call transcript text; and
determining a numeric sentiment classification by comparing the plurality of probability values to a plurality of thresholds respectively corresponding to the plurality of sentiment categories, wherein the numeric sentiment classification corresponds to a quality of the call.

18. The non-transitory computer-readable device of claim 17, wherein the preprocessing further comprises:
removing call transcript text corresponding to a customer care agent from the data.

19. The non-transitory computer-readable device of claim 17, wherein the preprocessing further comprises:
replacing one or more similar words from the call transcript text with a predetermined word.

20. The non-transitory computer-readable device of claim 17, wherein the plurality of sentiment categories include a positive numerical category, a negative numerical category, and a neutral category.
